(19) United States
(12) Patent Application Publication
(10) Pub. No.: US 2026/0171911 A1
(43) Pub. Date: Jun. 18, 2026

(54) METHOD FOR PROTECTING AN EXTERNAL CIRCUIT FROM A SURGE VOLTAGE

(71) Applicant: MAHLE International GmbH, Stuttgart (DE)

(72) Inventors: Thorsten Grelle, Stuttgart (DE); Peter Kozlowski, Stuttgart (DE); Penyo Topalov, Stuttgart (DE); Philipp Zimmerschied, Stuttgart (DE)

(21) Appl. No.: 18/710,608

(22) PCT Filed: Oct. 10, 2022
(86) PCT No.: PCT/EP2022/078065

§ 371 Date: May 15, 2024

(30) Foreign Application Priority Data
Nov. 15, 2021 (DE) 10 2021 212 797.5

(51) Int. Cl. H02M 3/156; H02M 1/08

(52) U.S. Cl. CPC H02M 3/156; H02M 1/08

(57) ABSTRACT

A method for protecting an external circuit from a surge voltage with a protective circuit, which may include a protective unit with a semiconductor switch switchable parallel to the external circuit and a voltage regulator, may include specifying to the voltage regulator a setpoint voltage correlating with a rated voltage of the external circuit. The method may also include tapping off, via the voltage regulator, an actual voltage correlating with a current voltage of the external circuit on the external circuit. The method may further include providing via the voltage regulator, dependent on a difference between the specified setpoint voltage and the tapped-off actual voltage, a GATE voltage on the semiconductor switch of the protective unit. Additionally, the method may include changing the current voltage in the external circuit via the semiconductor switch at the provided GATE voltage consuming a current flowing in the external circuit.

### CROSS-REFERENCE TO RELATED APPLICATIONS

This application claims priority to International Patent Application No. PCT/EP2022/078065, filed on Oct. 10, 2022, and German Patent Application No. DE 10 2021 212 797.5, filed on Nov. 15, 2021, the contents of both of which are hereby incorporated by reference in their entirety.

### TECHNICAL FIELD

The invention relates to a method for protecting an external circuit from a surge voltage by means of a protective circuit. The invention also relates to the protective circuit for carrying out the method.

### BACKGROUND

In order to limit surge voltage peaks in an electronic circuit, protective circuits with suppressor diodes or TVS diodes (TVS: transient voltage suppressor) are frequently used. However, the TVS diodes are generally optimised for very short peaks (μs to ms) and frequently not sufficiently robust for high surge voltages at low power. Thus, extended surge voltage peaks—in case of a fault or when the power demands on the synchronous machine change in dynamic driving situations—can occur for example in an externally excited synchronous machine. In this case, the protective circuit with the TVS diodes cannot sufficiently securely switch off the surge voltage peaks.

### SUMMARY

The object of the invention therefore is to state for a method and a protective circuit of the generic type an improved or at least alternative embodiment, with which the described disadvantages are overcome.

According to the invention, this object is solved through the subject matter of the independent claim(s). Advantageous embodiments are the subject matter of the dependent claim(s).

A method is provided for protecting an external circuit from a surge voltage by means of a protective circuit. The protective circuit comprises a protective unit with a semiconductor switch that can be switched parallel to the external circuit and a voltage regulator. In the method, a SETPOINT voltage correlating with a rated voltage of the external circuit is specified to the voltage regulator. In addition, the voltage regulator taps an ACTUAL voltage of the external circuit correlating with the current voltage of the external circuit. Depending on the difference between the specified SETPOINT voltage and the tapped ACTUAL voltage, the voltage regulator provides a GATE voltage on the semiconductor switch of the protective unit. With the applied GATE voltage, the semiconductor switch consumes a current flowing in the external circuit and thus changes the current voltage in the external circuit.

In the method according to the invention, the GATE voltage is regulated on the semiconductor switch and thus the resistance of the semiconductor switch changed. When the resistance is changed, the current consumed from the semiconductor switch and accordingly the current voltage in the external circuit also changes. Effectively, the protective circuit functions as a parallel path with a controlled resistance for receiving the excess energy.

The resistance of the semiconductor switch falls with the rising GATE voltage and rises with the falling GATE voltage. With the rising GATE voltage and the falling resistance, the semiconductor switch consumes ever more current of the external circuit. With the falling GATE voltage and the rising resistance, the semiconductor switch consumes ever less current of the external circuit. Thus, the GATE voltage on the semiconductor switch is regulated so that through the current taken off the semiconductor switch the current voltage in the external circuit is brought to below the rated voltage of the switching circuit. In other words, the GATE voltage on the semiconductor switch is regulated so that the current flowing through the semiconductor switch is sufficient for limiting the peak value of the current voltage in the external circuit. When the current voltage in the circuit is below the rated voltage, the semiconductor switch can be completely switched off.

In the method according to the invention, a better long-term power loss and a better control of the power behaviour can be advantageously achieved. In addition, costs compared with a protective circuit having classic TVS diodes can be reduced.

Advantageously, the method can be suitable for distinct applications. It is conceivable for example that the external circuit is a contactless rotor supply for an externally excited synchronous machine. It is also conceivable that the protective circuit is used as a controlled dissipative series resistor. Here, the protective circuit can be integrated for example in a circuit protective switch for pre-charge applications or for dissipation of the resonant energy of the rotor of an externally excited synchronous machine upon short circuit of the stator inverter.

In the protective circuit, the ACTUAL voltage correlates to the current voltage and the SETPOINT voltage correlates to the rated voltage. It is to be understood that the correlation is identical in both cases. It is conceivable for example that the ACTUAL voltage of the current voltage and the SETPOINT voltage of the rated voltage are identical. Alternatively it is also possible that the ACTUAL voltage differs from the current voltage and the SETPOINT voltage from the rated voltage by a scaling factor.

Accordingly, the protective unit can comprise a voltage divider connected parallel to the semiconductor switch. In the method, the current voltage in the external circuit can then be scaled by means of the voltage divider by a scaling factor specified by the voltage divider. The voltage regulator can then tap the scaled current voltage as the ACTUAL voltage. Practically, the SETPOINT voltage, which corresponds to the rated voltage of the external circuit pre-scaled by the scaling factor, is then specified to the voltage regulator. The voltage divider can comprise two resistance elements with electrical resistances differing from one another. The scaling factor is then defined by a ratio of resistances of the two resistance elements to one another and can, depending on the application case, be as large or small as desired. Advantageously, the scaling factor can be adapted to the SETPOINT voltage.

In the method it can be provided that the voltage regulator comprises an impedance converter. The ACTUAL voltage tapped from the external circuit can then be conducted via the impedance converter and thus be decoupled from the external circuit. By way of the impedance converter, the interactions between the voltage regulator and the external circuit can be excluded. The impedance converter can be designed in a manner known to the person skilled in the art. Advantageously, the impedance converter can comprise at least one resistance element and an operational amplifier. The at least one resistance element can be connected between an inverting input and an output of the operational amplifier.

Advantageously it can be provided that the voltage regulator comprises a PID control loop. In the method, the SETPOINT voltage and the ACTUAL voltage can then be specified to the PID control loop of the voltage regulator.

Dependent on the difference between the SETPOINT voltage and the ACTUAL voltage, the PID control loop can then provide the GATE voltage on the semiconductor switch. The PID control loop can be designed in a manner known to the person skilled in the art. Advantageously, the PID control loop can comprise an integrator circuit and an operational amplifier. The integrator circuit can be designed in a manner known to the person skilled in the art and comprise at least one capacitor and at least one resistance element, which are connected parallel to one another. The integrator circuit can be connected between an inverting input and an output of the operational amplifier. The SETPOINT voltage can be applied to the inverting input and the ACTUAL voltage can be applied to a non-inverting input of the operational amplifier. The GATE voltage for the semiconductor switch can be provided at the output of the operational amplifier.

As already explained above, the resistance of the semiconductor switch falls/rises with rising/falling GATE voltage and the current flowing through the semiconductor switch is changed. Thus, the current voltage in the external circuit also changes. The GATE voltage in turn depends on the current voltage in the circuit. Advantageously, the GATE voltage provided by the PID control loop can now settle at a value which is necessary in order to bring the current voltage in the external circuit to the rated voltage of the external circuit.

As soon as the current voltage of the external circuit falls below the rated voltage of the external circuit, the semiconductor switch can be switched off by the voltage regulator. In particular, no positive difference between the SETPOINT voltage and the ACTUAL voltage is determined in the PID controller of the voltage regulator at the two inputs any longer and accordingly no GATE voltage is provided by the PID controller. Accordingly, no GATE voltage is applied to the semiconductor switch and the semiconductor switch is switched off.

Advantageously, the protective circuit can comprise a current protective unit and a current regulator for regulating the current protective unit. In the method, the external circuit can then be also protected from a surge current. Thus, a power limitation system can be formed which can be operated over extended periods of time.

The invention also relates to a protective circuit for protecting an external circuit from a surge current. The protective circuit comprises a protective unit with a semiconductor switch and a voltage regulator. According to the invention, the protective circuit is designed for carrying out the method described above.

Advantageously, the semiconductor switch of the protective unit can be a bipolar transistor with an insulated gate electrode.

The protective unit can comprise a voltage divider with at least two electrical resistance elements for specifying a scaling factor for the ACTUAL voltage. The voltage divider can be connected parallel to the semiconductor switch.

The voltage regulator can comprise an impedance converter, wherein the impedance converter is directly connected to the protective unit of the protective circuit. The impedance converter can be designed in a manner known to the person skilled in the art. Advantageously, the impedance converter can comprise at least one resistance element and an operational amplifier.

The voltage regulator can comprise a PID control loop, wherein the PID control loop is interconnected with the external circuit for tapping the ACTUAL voltage, with an external source for tapping a SETPOINT voltage and with the semiconductor switch for specifying the GATE voltage. The PID control loop can be designed in a manner known to the person skilled in the art. Advantageously, the PID control loop can comprise an integrator circuit and an operational amplifier.

In order to avoid repetitions, reference is made here to the above explanations.

Further important features and advantages of the invention are obtained from the subclaims, from the drawings and from the associated figure description by way of the drawings.

It is to be understood that the features mentioned above and still to be explained in the following cannot only be used in the respective combination stated but also in other combinations or by themselves without leaving the scope of the present invention.

Preferred exemplary embodiments of the invention are shown in the drawings and are explained in more detail in the following description, wherein same reference numbers relate to same or similar or functionally same components.

### BRIEF DESCRIPTION OF THE DRAWINGS

It shows, in each case schematically

FIG. 1 shows a circuit of a protective circuit according to the invention with an external circuit;

FIG. 2 shows temporal progressions of voltages and currents in the circuit according to FIG. 1.

### DETAILED DESCRIPTION

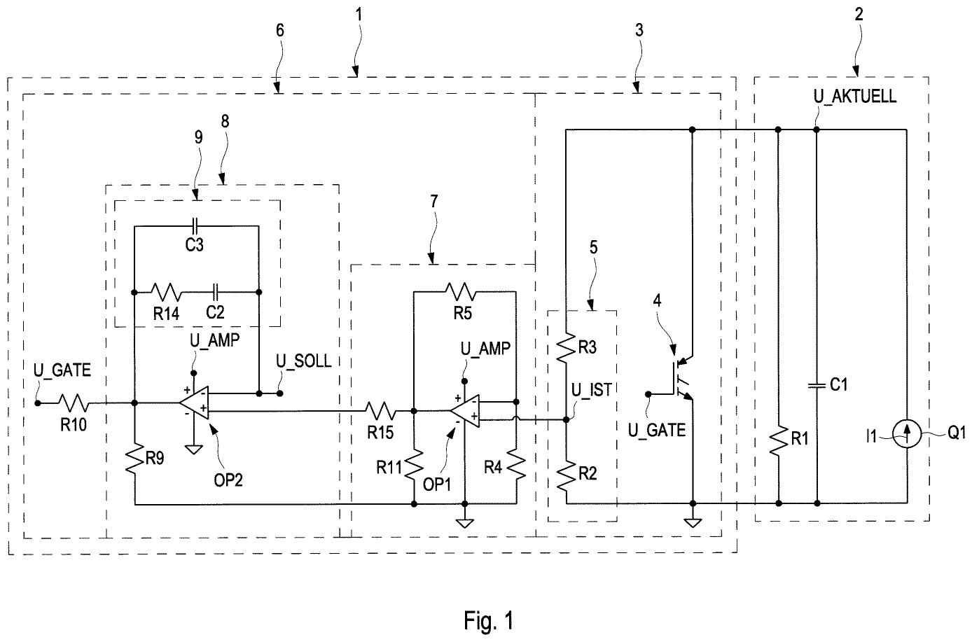

FIG. 1 shows a circuit of a protective circuit 1 according to the invention with an external circuit 2. The external circuit 2 comprises a current source Q1, a capacitor C1 and a resistance element R1. The current source Q1, the capacitor C1 and the resistance element R1 are connected parallel to one another. It is to be understood that the shown external circuit 2 is only exemplarily. The shown external circuit 2 is not part of the present invention.

The protective circuit 1 according to the invention comprises a protective unit 3 with a semiconductor switch 4 and with a voltage divider 5, which is formed from two resistance elements R2 and R3. The voltage divider 5 specifies a scaling factor which is determined by a ratio of electrical resistances of the two resistance elements R2 and R3. In addition, the protective circuit 1 comprises a voltage regulator 6 with an impedance converter 7 and a PID control loop 8. The impedance converter 7 comprises a first operational amplifier OP1 and resistance elements R4, R5, R11 and R15. The PID control loop 8 comprises an integrator circuit 9 with two capacitors C2 and C3 and resistance element R14. In addition, the PID control loop 8 comprises a second operational amplifier OP2 and two resistance elements R9 and R10.

The current source Q1 generates a current I1 and a current voltage U_AKTUELL is applied to the elements of the external circuit 2. At the voltage divider 5, an actual voltage U_IST is applied, which corresponds to the current voltage U_AKTUELL scaled by the scaling factor. The actual voltage U_IST is tapped the voltage regulator and by way of the impedance converter 7 decoupled from the external circuit 2. Following this, the actual voltage U_IST is conducted to the second operational amplifier OP2 of the PID control loop 8. In addition, a setpoint voltage U_SOLL is applied to the second operational amplifier OP2 of the PID control loop 8, which corresponds to a rated voltage of the external circuit 2 scaled by the scaling factor.

Dependent on the difference of the actual voltage U_IST and the setpoint voltage U_SOLL, the second operational amplifier OP2 outputs a GATE voltage U_GATE at its inputs, which is now applied to the semiconductor switch 4. When the actual voltage U_IST exceeds the setpoint voltage U_SOLL, the semiconductor switch 4 is switched on and otherwise switched off. The GATE voltage U_GATE rises and falls with the mentioned difference, so that dependent on this a resistance of the semiconductor switch 4 is also changed. The resistance of the semiconductor switch 4 falls with the rising GATE voltage U_GATE and rises with the falling GATE voltage U_GATE. When the GATE voltage U_GATE rises, the resistance of the semiconductor switch 4 falls and it consumes ever more current in the external circuit 2. Thus, the current voltage U_AKTUELL in the internal circuit 2 falls. When the GATE voltage U_GATE falls, the resistance of the semiconductor switch 4 rises and it consumes ever less current in the external circuit 2. Thus, the current voltage U_AKTUELL in the external circuit 2 rises. Thus, the GATE voltage and the resistance of the semiconductor switch 4 settle at a value at which the current voltage U_AKTUELL corresponds exactly to the rated voltage of the external circuit.

The two operational amplifiers OP1 and OP2 are each supplied with a supply voltage U_AMP of a supply source. It is conceivable that the two operational amplifiers OP1 and OP2 are supplied with the supply voltage U_AMP from the same supply source. The supply source can additionally provide also the setpoint voltage U_SOLL. For this, the supply voltage U_AMP of the supply source can be scaled by a further voltage divider. It is additionally conceivable that the two operational amplifiers OP1 and OP2 are arranged or fastened or integrated in a common component.

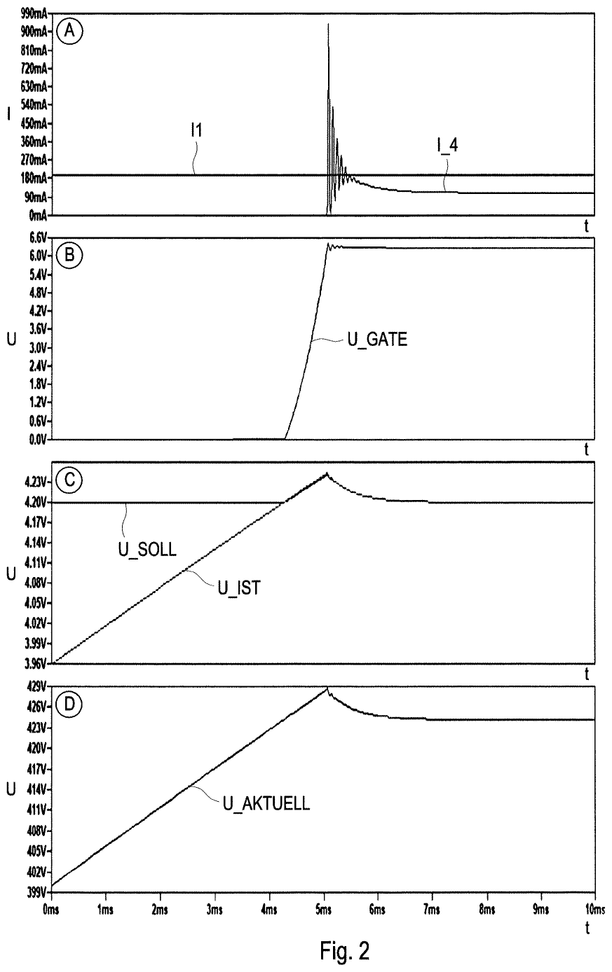

The protective circuit 1 is designed for carrying out a method 10 according to the invention. The method 10 is explained in more detail by way of FIG. 2.

FIG. 2 shows temporal progressions of voltages and currents in the circuit according to FIG. 1 corresponding to a simulation of the method 10 according to the invention. In a part-image A, a temporal progression of the current I1 of the current source Q1 and a temporal progression of the current I-4 taken off the semiconductor switch 4 are shown. In a part-image B, a temporal progression of the GATE voltage U_GATE is shown. In a part-image C, a temporal progression of the actual voltage U_IST and a temporal progression of the setpoint voltage U_SOLL are shown. In a part-image D, a temporal progression of the current voltage U_AKTUELL in the external circuit 2 is shown.

Exemplary values where set during the simulation. Here, the current source Q1 provides the current I1 to the amount of 200 mA. The resistance element R1 comprises a resistor of 5 kΩ. The voltage divider 5 scales the current voltage U_AKTUELL in the external circuit 2 to the actual voltage U_IST with a scaling factor equal to 100. The rated voltage of the external circuit 2 is set to 420 V. The setpoint voltage U_SOLL corresponds to the rated voltage of the external circuit 2 scaled by the scaling factor 100 and amounts to 4.2 V. The voltage regulator is thus set to the rated voltage of 420 V.

At the current voltage U_AKTUELL of 400 V, the resistance element R1 with the resistor of 5 kΩ consumes the current in the amount of 80 mA. However, the current source Q1 supplies the current I1 of 200 mA. Thus, the current voltage U_AKTUELL in the resistance element R1 rises. When the current voltage U_AKTUELL rises above 420 V and the actual voltage thus over 4.2 V, the second operational amplifier OP2 applies the GATE voltage U_GATE to the semiconductor switch 4. Thus, the semiconductor switch 4 is switched on. The GATE voltage U_GATE settles at a value at which the semiconductor switch 4 consumes exactly the excess current of 120 mA in the external circuit 2. This behaviour corresponds to that of a conventional TVS diode, but makes possible a higher long-term power loss and a better control of the system behaviour.

1. A method for protecting an external circuit from a surge voltage with a protective circuit, the protective circuit including a protective unit with a semiconductor switch switchable parallel to the external circuit and a voltage regulator, the method comprising:
specifying to the voltage regulator a setpoint voltage correlating with a rated voltage of the external circuit;
tapping off, via the voltage regulator, an actual voltage correlating with a current voltage of the external circuit on the external circuit;
providing via the voltage regulator, dependent on a difference between the specified setpoint voltage and the tapped-off actual voltage, a GATE voltage on the semiconductor switch of the protective unit; and
changing the current voltage in the external circuit via the semiconductor switch at the provided GATE voltage consuming a current flowing in the external circuit.

2. The method according to claim 1, wherein:
the protective unit includes a voltage divider connected parallel to the semiconductor switch;
the method further comprises scaling the current voltage in the external circuit via the voltage divider by a scaling factor specified by the voltage divider;
the current voltage is tapped from the voltage regulator as the actual voltage; and
the voltage regulator is specified the setpoint voltage which corresponds to the rated voltage of the external circuit pre-scaled by the scaling factor.

3. The method according to claim 1, wherein:
the voltage regulator includes an impedance converter; and
the method further comprises decoupling the actual voltage tapped in the external circuit from the external circuit via conducting the actual voltage tapped in the external circuit via the impedance converter.

4. The method according to claim 1, wherein:
the voltage regulator includes a PID control loop;
the PID control loop is specified the setpoint voltage and the actual voltage; and
the method further comprises, dependent on a difference between the setpoint voltage and the actual voltage, providing via the PID control loop the GATE voltage at the semiconductor switch.

5. The method according to claim 4, wherein:
the voltage regulator includes an impedance converter; and
the method further comprises:
decoupling the actual voltage tapped in the external circuit from the external circuit via conducting the actual voltage tapped in the external circuit via the impedance converter; and
providing the PID control loop with the actual voltage decoupled by the impedance converter.

6. The method according to claim 4, further comprising settling the GATE voltage provided by the PID control loop at a value necessary to bring the current voltage in the external circuit to the rated voltage of the external circuit.

7. The method according to claim 2, wherein the scaling factor is matched to the setpoint voltage.

8. The method according to claim 1, further comprising, as soon as the current voltage of the external circuit falls below the rated voltage of the external circuit, switching off the semiconductor switch with the voltage regulator.

9. A protective circuit for protecting an external circuit from a surge voltage, comprising a protective unit with a semiconductor switch and a voltage regulator, wherein:
the protective circuit is configured to carry out the method according to claim 1.

10. The protective circuit according to claim 9, wherein the semiconductor switch of the protective unit is a bipolar transistor with an insulated gate electrode.

11. The protective circuit according to claim 9, wherein:
the protective unit includes a voltage divider connected parallel to the semiconductor switch; and
the voltage divider includes at least two resistance elements for specifying a scaling factor for the actual voltage.

12. The protective circuit according to claim 9, wherein the voltage regulator includes an impedance converter that is directly connected to the protective unit.

13. The protective circuit according to claim 9, wherein:
the voltage regulator includes a PID control loop; and
the PID control loop is interconnected with:
the external circuit for tapping the actual voltage;
an external source for tapping the setpoint voltage; and
the semiconductor switch for specifying the GATE voltage.

14. The protective circuit according to claim 9, wherein:
the semiconductor switch is a bipolar transistor with an insulated gate electrode;
the protective unit includes a voltage divider connected parallel to the semiconductor switch;
the voltage divider includes at least two resistance elements for specifying a scaling factor for the actual voltage;
the voltage regulator includes (i) an impedance converter that is directly connected to the protective unit and (ii) a PID control loop; and
the PID control loop is interconnected with:
the external circuit for tapping the actual voltage;
an external source for tapping the setpoint voltage; and
the semiconductor switch for specifying the GATE voltage.

15. The method according to claim 1, wherein the semiconductor switch is a bipolar transistor with an insulated gate electrode.

16. The method according to claim 2, wherein:
the voltage divider includes at least two resistance elements; and
the method further comprises specifying the scaling factor for the actual voltage via the at least two resistance elements.

17. The method according to claim 3, wherein the impedance converter is directly connected to the protective unit.

18. The method according to claim 4, wherein the PID control loop is interconnected with:
the external circuit for tapping the actual voltage;
an external source for tapping the setpoint voltage; and
the semiconductor switch for specifying the GATE voltage.

19. The method according to claim 4, further comprising tapping, via the PID control loop, the actual voltage from the external circuit.

20. The method according to claim 4, further comprising tapping, via the PID control loop, the setpoint voltage from an external source.
